(19) United States
(12) Patent Application Publication
(10) Pub. No.: US 2014/0182263 A1
(43) Pub. Date: Jul. 3, 2014

(54) Maphbe Turbine

(71) Applicant: Marc Gregory Allinson, Kingsville, MD (US)

(72) Inventor: Marc Gregory Allinson, Kingsville, MD (US)

(21) Appl. No.: 13/998,955

(22) Filed: Dec. 27, 2013

Related U.S. Application Data
(60) Provisional application No. 61/848,200, filed on Dec. 27, 2012.
(60) Provisional application No. 61/850,407, filed on Feb. 14, 2013.
(60) Provisional application No. 61/851,414, filed on Mar. 7, 2013.

(51) Int. Cl. F03D 9/00; F02C 7/00; F03D 11/00; F03D 5/00; F03D 11/04

(52) U.S. Cl. CPC F03D 9/002; F03D 5/00; F03D 11/045; F03D 11/00; F02C 7/00; F03D 9/001
USPC 60/39.01; 60/698; 416/244 R; 415/182.1; 417/334; 310/311

(57) ABSTRACT

The Maphbe Turbine is a system of nozzles, rotors, and energy storage devices used to generate consistent power from intermittent energy sources specifically wind. It uses sails, cables, and poles as a way to form large nozzles and rotors for power generation, these systems can be paired with other renewable sources for co-generation, and can be used for powering pumped storage hydro stations, excess energy can be stored in multi-layer carbon nanotube capacitors. Another application for the invention is offshore floating wind farms to make giant collapsible nozzles and turbines paired with solar, and or wave energy devices.

### CROSS REFERENCE

This Invention, Maphbe Turbine, claims the filing date of provisional patent 61/848,200 with priority filing date Dec. 27, 2012, provisional patent 61/850,407 with priority date Feb. 14, 2013, and provisional patent 61/851,414 with priority date Mar. 7, 2013.

### TECHNICAL FIELD

The present invention relates to a fluid turbine and energy storage system to be used to provide electrical power and energy strorage.

### BACKGROUND

The Maphbe Turbine is a fluid mechanic based energy generation and storage system. Past attempts are turbine nozzles and rotor design have limitations to size, by using sails the size of the nozzles can be scaled up.

### BRIEF SUMMARY OF THE INVENTION

The Maphbe Turbine is a system power generation systems designed to increase the scalability of renewable power generation in the area of fluid mechanics. Its novel contruction using giant nozzles made from sails, pumped storage, and floating wind structures gives it a distinct advantage over traditional renewable systems.

### DESCRIPTION OF THE DRAWINGS

FIG. 1A, 1B, and 1C: 1A depicts a configuration of the Maphbe Turbine with sail nozzles funneling flows into a ducted turbine with claimed horizontal axis rotor configuration with vertical axis turbines on the pole and on top of the duct; 1B depicts the claimed rotor as does 1C

FIG. 2: This image depicts a possible sail configuration for the maphbe turbine with a 3 bladed turbine between the sail funnel and ribbing changing the configuration of the sails.

FIG. 3A and 3B: FIG. 3A depicts a series of turbines mounted on a pumped storage system with triangular sails used to funnel wind into the turbines; FIG. 3B depicts a series of wind turbines and sail nozzles.

FIG. 4A, 4B, 4C, 4D, 4E, 4F: 4A, 4B, 4C, 4D, 4E depict the structure of the multi-direction sail and cable nozzle system with 4F depicting the nozzle mounted on a water tank with the claimed turbine the water discharge pipe.

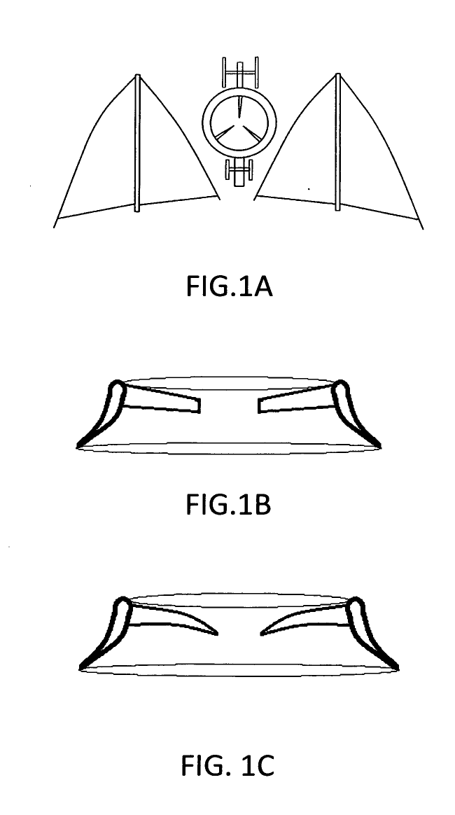

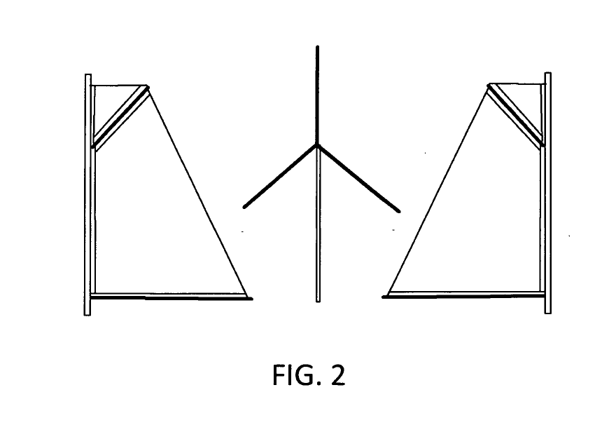

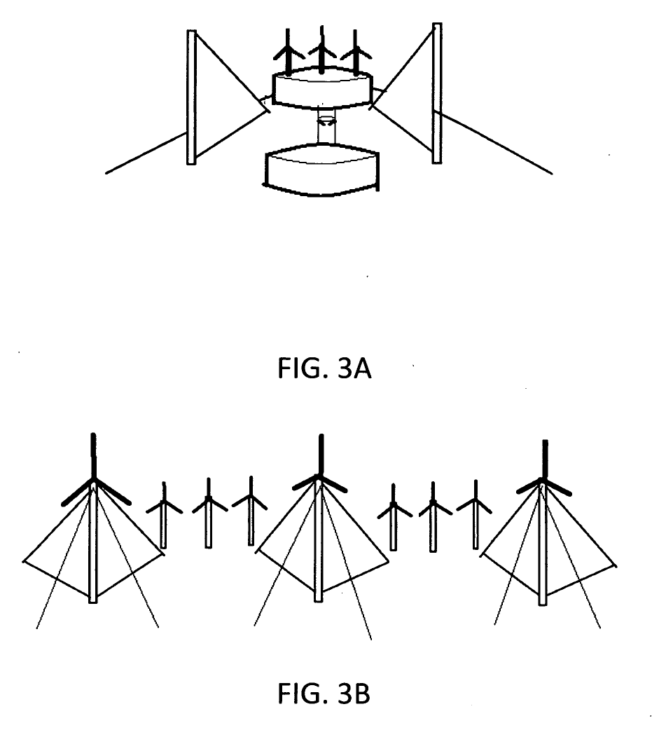

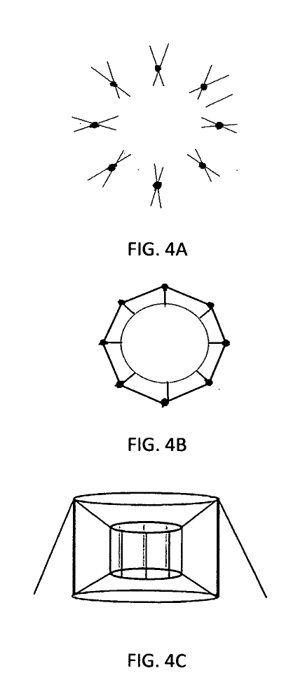

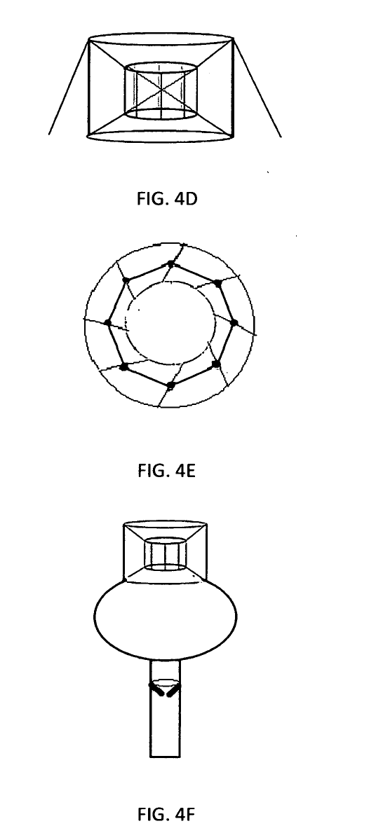

### DETAILED DESCRIPTION OF THE INVENTION

The Maphbe Turbine is a system of nozzles, rotors, and energy storage devices used to generate consistent power from intermittent energy sources specifically wind. It uses sails, cables, and poles as a way to form large nozzles and rotors for power generation, these systems can be paired with other renewable sources for co-generation, and can be used for powering pumped storage hydro stations, excess energy can be stored in multi-layer carbon-nanotube capacitors. Another application for the invention is offshore floating wind farms to make giant collapsible nozzle paired with solar, and or wave energy devices.

1. A method of using sails attached to masts to funnel wind at a wind turbine or wind farm whether wind turbines are vertical axis and/or horizontal axis and/or ducted; turbines, lights, and or cell phone/radio transmission can be placed on top of the masts.

2. Dependent on claim 1, masts and/or high tension cables and or turbines can utilize piezoelectric materials to generate electricity from stress generated by the sails, mast, turbines, and or cables.

3. Dependent on claim 1, the wind turbine/wind farm can include cogeneration with other energy sources including but not limited to fossil fuels, solar, either conventional PV, solar printed, wave energy, hydro pumped storage, energy storage systems, carbon nano-tube multilayer capacitors, smart grids, and/or gas turbines.

4. Dependent on claim 1, the turbine system can float and include a wave energy system through moorings to the ocean floor.

5. Dependent on claim 1, turbines can be mounted on the masts forming the nozzle as well as on the masts of horizontal axis turbines.

6. Dependent on claim 1, the bearings for the turbine can be constructed from low friction carbon, the sails and poles turbines can be woven from carbon fibers and composites, and/or other materials.

7. Dependent on claim 1 the turbine/or duct and be constructed from sails/fabric, ribbing, struts and wires to decrease weight and increase size including but not limited to vertical axis blades, horizontal axis blades, nozzles.

8. A multi-directional wind turbine nozzle with turbine at the center of the nozzle, though the nozzle can change shape/have less or more poles, can be collapsible, and to also be used to collect water into a tank which can be a water tower and/or a fish aquarium that gravity feeds hydroponic grow systems and or earthen based irrigation and/or municipal water, when integrated into a structure it cools the structure

9. Dependent on claim 8, A nozzle constructed from ribbing, sail/fabric/sheeting, and cables to be used for wind and/or water turbines such that structure is supported through tension between the cables, poles, sails, and flow such that the shape of the nozzle can change and the nozzle can be collapsed depending on wind direction and strength.

10. A fluid turbine spun by opposing lift along a central axis.

11. Dependent on claim 10, a rotor configuration that can be used in pumped storage hydro energy recovery/municipal lines and as a gas turbine.
